(19) United States
(12) Patent Application Publication
(10) Pub. No.: US 2022/0149657 A1
(43) Pub. Date: May 12, 2022

(54) POWER RECEIVING DEVICE, MOVABLE UNIT, WIRELESS POWER TRANSMISSION SYSTEM, AND MOVABLE UNIT SYSTEM

(71) Applicant: PANASONIC INTELLECTUAL PROPERTY MANAGEMENT CO.,LTD., Osaka (JP)

(72) Inventors: Kazunori SATO, Osaka (JP); Satoru KIKUCHI, Osaka (JP)

(21) Appl. No.: 17/598,518

(22) PCT Filed: Mar. 26, 2020
(86) PCT No.: PCT/JP2020/013809

§ 371 Date: Sep. 27, 2021

(30) Foreign Application Priority Data
Mar. 28, 2019 (JP) 2019-063716

(51) Int. Cl. H02J 50/05; H02J 50/90; H02J 50/40; H02J 7/02; H02J 7/00; H02J 50/12; B60L 53/12; B60L 53/22; B60L 53/62

(52) U.S. Cl. CPC H02J 50/05; H02J 50/90; H02J 50/40; H02J 7/02; H02J 7/0068; H02J 7/0063; B60L 2210/10; H02J 50/12; B60L 53/12; B60L 53/22; B60L 53/62; H02J 2207/20; H02J 7/007182

(57) ABSTRACT

A power receiving device includes: a power receiving antenna to wirelessly receive AC power from a power transmitting antenna in a power transmitting device; a power receiving circuit to convert the AC power received by the power receiving antenna into DC power and to output the DC power; a charge-discharge control circuit to control charging and discharging of an electrical storage device to be charged by the DC power output from the power receiving circuit; and a switching circuit connected between the power receiving circuit and the charge-discharge control circuit and between the electrical storage device or the other electrical storage device and the charge-discharge control circuit. The charge-discharge control circuit is booted by energy that is stored in the electrical storage device or another electrical storage device. The switching circuit switches between a first state in which power is supplied from the electrical storage device or the other electrical storage device to the charge-discharge control circuit and a second state in which power is supplied from the power receiving circuit to the charge-discharge control circuit.

### TECHNICAL FIELD

The present disclosure relates to a power receiving device, a movable unit, a wireless power transmission system, and a movable unit system.

### BACKGROUND ART

Recent years have seen development of wireless power transmission techniques for wirelessly (contactlessly) transmitting electric power to devices that are capable of moving or being moved, e.g., electric vehicles and mobile phones. For example, Patent Document 1 and Patent Document 2 disclose examples of wireless power transmission techniques.

Patent Document 1 discloses a power supplying device which wirelessly transmits electric power to a power receiving device that is mounted in a movable unit. The power supplying device includes a feeding coil to generate a first magnetic field and an auxiliary feeding coil to generate a second magnetic field of a smaller intensity than that of the first magnetic field. Along the traveling direction of the movable unit, the feeding coil and the auxiliary feeding coil are placed, from the nearer side, in the order of the auxiliary feeding coil and then the feeding coil. Prior to receiving electric power via the first magnetic field, a charging section in the movable unit starts booting upon receiving electric power via the second magnetic field. This ensures that the charging section is already on standby by the time power is received via the first magnetic field that is generated by the feeding coil.

Patent Document 2 discloses a charging system in which power is supplied contactlessly from a power transmitter to a power receiver. The power receiver includes a power receiving coil, a rectifier circuit, a DC-DC converter, a variable impedance section, and a control section. While changing stepwise setting values for the impedance of the variable impedance section from an initial value that is greater than the impedance of a load device to a final value that is equal to the impedance of the load device, the control section boots the DC-DC converter. This restrains any overvoltage exceeding the withstand voltage of the DC-DC converter from occurring, whereby electric power is stably supplied to the load device.

### CITATION LIST

### Patent Literature

[Patent Document 1] Japanese Laid-Open Patent Publication No. 2017-147822

[Patent Document 2] Japanese Laid-Open Patent Publication No. 2016-220307

### SUMMARY OF INVENTION

### Technical Problem

The present disclosure provides a technique for improving the stability of power transmission in a system where an electrical storage device is charged through wireless power transmission.

### Solution to Problem

A power receiving device according to one implementation of the present disclosure is used in a wireless power transmission system that includes a power transmitting device and a power receiving device. The power receiving device includes: a power receiving antenna to wirelessly receive AC power from a power transmitting antenna in the power transmitting device; a power receiving circuit to convert the AC power received by the power receiving antenna into DC power and to output the DC power; a charge-discharge control circuit to control charging and discharging of an electrical storage device to be charged by the DC power output from the power receiving circuit; and a switching circuit. The charge-discharge control circuit is booted by energy that is stored in the electrical storage device or another electrical storage device. The switching circuit is connected between the power receiving circuit and the charge-discharge control circuit and between the electrical storage device or the other electrical storage device and the charge-discharge control circuit. The switching circuit is capable of switching between a first state in which power is supplied from the electrical storage device or the other electrical storage device to the charge-discharge control circuit and a second state in which power is supplied from the power receiving circuit to the charge-discharge control circuit. General or specific aspects of the present disclosure may be implemented using a system, an apparatus, a method, an integrated circuit, a computer program, or a storage medium, or any combination of a system, an apparatus, a method, an integrated circuit, a computer program, and/or a storage medium.

### Advantageous Effects of Invention

According to the technique of the present disclosure, stability of power transmission in a system in which an electrical storage device is charged via wireless power transmission can be improved.

### BRIEF DESCRIPTION OF DRAWINGS

FIG. 1 A diagram schematically showing an example of a wireless power transmission system.

FIG. 2 A diagram showing the general configuration of the wireless power transmission system.

FIG. 3 A diagram showing a more specific circuit configuration of a power transmitting circuit and a power receiving circuit.

FIG. 4 A diagram showing an example of dependence of the output voltage of the power receiving circuit on load impedance.

FIG. 5 A block diagram showing the configuration of a wireless power transmission system according to an illustrative embodiment of the present disclosure.

FIG. 6 A diagram showing a more specific exemplary configuration of a power transmitting circuit and a power receiving circuit.

FIG. 7A A diagram schematically showing an exemplary configuration of an inverter circuit.

FIG. 7B A diagram schematically showing an exemplary configuration of a rectifier circuit.

FIG. 8 A diagram showing an exemplary configuration of a charge-discharge control circuit.

FIG. 9 A diagram showing an exemplary configuration of a switching circuit.

FIG. 10 A diagram showing another exemplary configuration for the switching circuit.

FIG. 11 A diagram showing another exemplary configuration for the switching circuit.

FIG. 12 A diagram showing another exemplary configuration for the switching circuit.

FIG. 13A A diagram schematically showing a current path before the charge-discharge control circuit is booted.

FIG. 13B A diagram schematically showing a current path after the charge-discharge control circuit is booted.

FIG. 14 A diagram showing an example system including a control device and a sensor.

FIG. 15 A diagram showing an example system including two electrical storage devices.

FIG. 16 A perspective view showing an example system in which the transmission electrodes and the reception electrodes each include four electrodes.

FIG. 17 A block diagram showing the configuration of a system in which the transmission electrodes and the reception electrodes each include four electrodes.

FIG. 18A A diagram showing an example where the transmission electrodes are installed on a lateral surface e.g., a wall.

FIG. 18B A diagram showing an example where the transmission electrodes are installed on a ceiling.

FIG. 19 A block diagram showing an example system in which electric power is wirelessly transmitted through magnetic field coupling between coils.

### DESCRIPTION OF EMBODIMENTS

(Findings Providing the Basis of the Present Disclosure)

Prior to describing embodiments of the present disclosure, findings providing the basis of the present disclosure will be described.

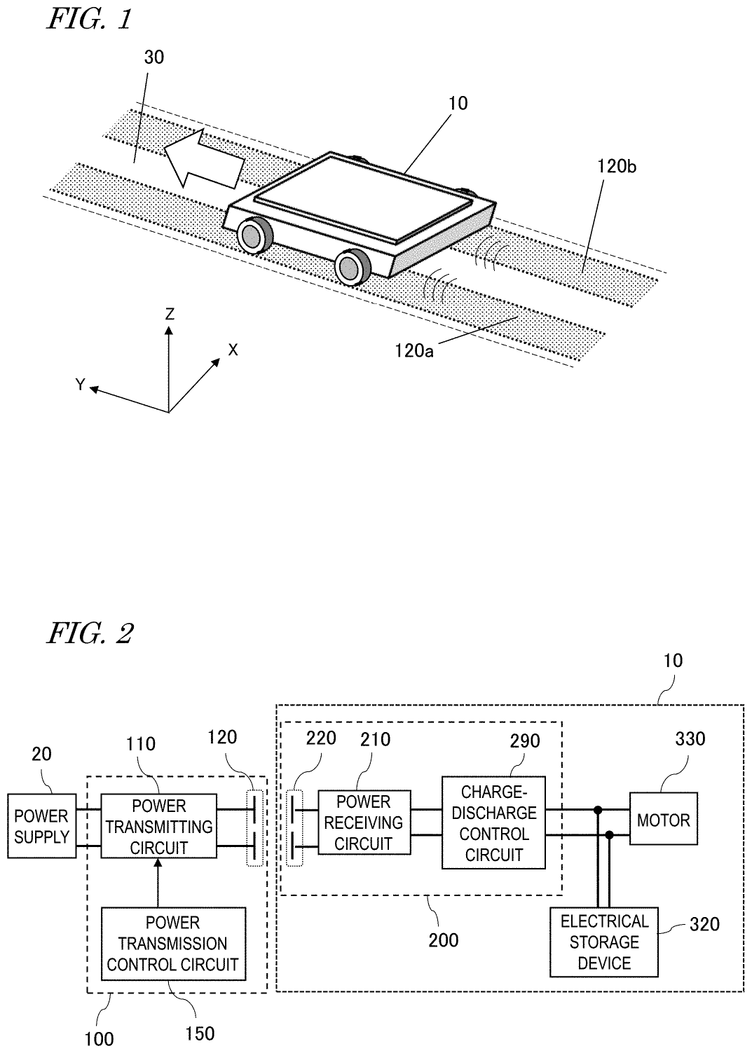

FIG. 1 is a diagram schematically showing an example of a wireless power transmission system. The wireless power transmission system shown in the figure may be a system which wirelessly transmits electric power, through electric field coupling between electrodes, to a movable unit 10 that is used in transporting articles in a factory or a warehouse, for example. The movable unit 10 in this example is an automated guided vehicle (AGV). In this system, a pair of transmission electrodes 120a and 120b, which are in plate shape, are disposed on the floor surface 30. The pair of transmission electrodes 120a and 120b have a shape that is elongated in one direction. To the pair of transmission electrodes 120a and 120b, AC power is supplied from a power transmitting circuit not shown.

The movable unit 10 includes a pair of reception electrodes (not shown) opposing the pair of transmission electrodes 120a and 120b. With the pair of reception electrodes, the movable unit 10 receives AC power which has been transmitted from the transmission electrodes 120a and 120b. The received electric power is supplied to a load in the movable unit 10, e.g., a motor, a secondary battery, or a capacitor for electrical storage purposes. With this, the movable unit 10 may be driven or charged.

FIG. 1 shows XYZ coordinates indicating the X, Y and Z directions which are orthogonal to one another. The following description will rely on XYZ coordinates as shown in the figures. The direction that the transmission electrodes 120a and 120b extend will be referred to as the Y direction; a direction which is perpendicular to the surface of the transmission electrodes 120a and 120b as the Z direction; and a direction which is perpendicular to the Y direction and the Z direction as the X direction. Note that the orientation of any structure that is shown in a drawing of the present application is so set for ease of description, and it shall not limit the orientation in which an embodiment of the present disclosure may actually be employed. Moreover, the particular shape and size with which the whole or a part of any structure may be presented in a drawing shall not limit its actual shape and size. In the following description, the pair of transmission electrodes 120a and 120b may be indiscriminately referred to as the “transmission electrodes 120”. Similarly, the pair of reception electrodes 220a and 220b may be indiscriminately referred to as the “reception electrodes 220”.

FIG. 2 is a diagram showing the general configuration of the wireless power transmission system shown in FIG. 1. The wireless power transmission system includes a power transmitting device 100 and a movable unit 10.

The power transmitting device 100 includes a pair of transmission electrodes 120, a power transmitting circuit 110 which supplies AC power to the transmission electrodes 120, and a power transmission control circuit 150 which controls the power transmitting circuit 110. The power transmitting circuit 110 may include various circuits, such as an inverter circuit and an impedance matching circuit, for example. The power transmitting circuit 110 converts DC or AC power which is supplied from a power supply 20 into AC power for power transmission, and outputs it to the pair of transmission electrodes 120. The power transmission control circuit 150 controls an inverter circuit that is included in the power transmitting circuit 110 to adjust the AC power to be output from the power transmitting circuit 110.

The movable unit 10 includes a power receiving device 200, an electrical storage device 320, and an electric motor 330. The power receiving device 200 includes a pair of reception electrodes 220, a power receiving circuit 210, and a charge-discharge control circuit 290. Through electric field coupling between the pair of transmission electrodes 120 and the pair of reception electrodes 220, electric power is wirelessly transmitted while the two pairs are opposed to each other. The electrical storage device 320 is a device that stores electric power, e.g., a secondary battery or a capacitor for electrical storage purposes. The power receiving circuit 210 converts the AC power received by the reception electrodes 220 into a voltage required by the electrical storage device 320 and the motor 330, e.g., a DC voltage of a predetermined voltage level, and outputs it. The power receiving circuit 210 may include various circuits, e.g., a rectifier circuit and an impedance matching circuit. The charge-discharge control circuit 290 is a circuit that controls charging and discharging of the electrical storage device 320. While monitoring the voltage of the electrical storage device 320, the charge-discharge control circuit 290 supplies electric power to the electrical storage device 320 until the voltage reaches a predetermined value. As a result of this, charging of the electrical storage device 320 is realized. The movable unit 10 may also include other component elements not shown, e.g., a motor control circuit and a driving wheel(s).

In accordance with the aforementioned wireless power transmission system, the movable unit 10 is able to wirelessly receive electric power while moving along the transmission electrodes 120. While maintaining a state where the transmission electrodes 120 and the reception electrodes 220 are opposed to each other in proximity, the movable unit 10 is able to move along the transmission electrodes 120. As a result, the movable unit 10 is able to move while charging the electrical storage device 320, e.g., a battery or a capacitor, for example.

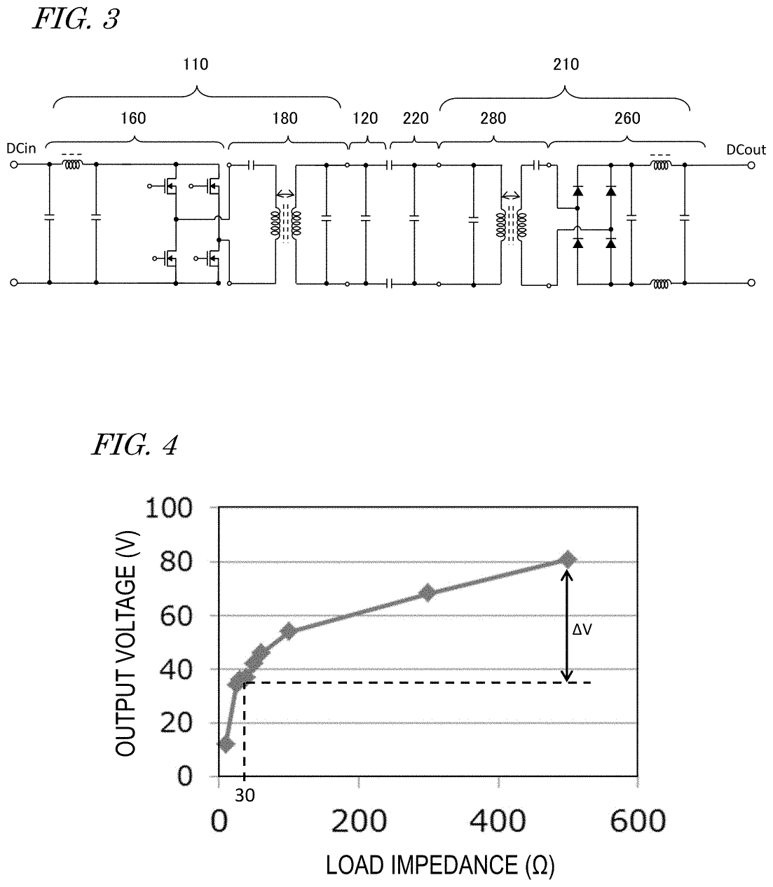

FIG. 3 is a diagram showing a more specific circuit configuration of the power transmitting circuit 110, the transmission electrodes 120, the reception electrodes 220, and the power receiving circuit 210. In this example, the power transmitting circuit 110 includes an inverter circuit 160 and a matching circuit 180. The power receiving circuit 210 includes a matching circuit 280 and a rectifier circuit 260. The inverter circuit 160, the matching circuit 180, and the transmission electrodes 120 are connected in this order. The reception electrodes 220, the matching circuit 280, and the rectifier circuit 260 are connected in this order. The inverter circuit 160 converts a DC voltage DCin which is output from the power supply to an AC voltage for power transmission, which has a relatively high frequency (e.g. about 500 kHz). The matching circuit 180 is provided for the sake of impedance matching between the inverter circuit 160 and the transmission electrodes 120. The matching circuit 180 steps up the AC voltage resulting from conversion by the inverter circuit 160 into a higher AC voltage, and outputs it to the transmission electrodes 120. The matching circuit 280 on the power-receiving side is provided for the sake of impedance matching between the reception electrodes 220 and the rectifier circuit 260. The matching circuit 280 steps down the high AC voltage received by the reception electrodes 220 into a lower AC voltage. The rectifier circuit 260 converts the stepped-down AC voltage into a DC voltage DCout for use by the load and outputs it.

In such a wireless power transmission system, the state of power transmission significantly changes when the impedance of a load connected to the power receiving circuit 210, such as the charge-discharge control circuit 290, the motor 330, or the electrical storage device 320, changes. As a result, various problems may arise, such as fluctuations of the output voltage or lowering of the transmission efficiency.

FIG. 4 is a graph showing example of changes in the output voltage DCout when, in the circuit configuration shown in FIG. 3, the impedance of a load connected to the power receiving circuit 210 is changed. This graph shows a dependence of the output voltage DCout on the load impedance in the case where the parameters of circuit elements in the circuit shown in FIG. 3 are set to values which may actually be used and the input voltage DCin is set to 40 V. In this example, the design value of the load impedance is 30Ω. As the load impedance deviates from 30Ω, the difference ΔV between the actual value and the design value of the output voltage DCout increases.

Such fluctuations in load impedance may notably occur during the boot of the charge-discharge control circuit 290, for example. When the movable unit 10 moves to near the transmission electrodes 120 for charging, a processor in the charge-discharge control circuit 290 begins operation for booting. During boot, the charge-discharge control circuit 290 does not output any current; consequently, the output impedance of the power receiving circuit 210 increases. When boot is complete, the impedance is approximately the design value. Therefore, during boot, the output voltage of the power receiving circuit 210 significantly increases.

Thus, when the charge-discharge control circuit 290 boots up in order to begin charging, characteristics of the wireless power transmission may significantly fluctuate. This may risk degrading the transmission efficiency, or damaging elements within the circuitry, for example. It is desirable to keep a constant load impedance during wireless power transmission.

The aforementioned problem may occur not only in wireless power transmission systems based on an electric field coupling method as shown in FIGS. 1 to 3, but also in any wireless power transmission system based on a magnetic field coupling method that utilizes coupling between coils.

The inventors have arrived at the configurations of embodiments of the present disclosure as described below, in order to prevent the load impedance from significantly fluctuating during wireless power transmission.

A power receiving device according to one implementation of the present disclosure is used in a wireless power transmission system that includes a power transmitting device and a power receiving device. The power receiving device includes: a power receiving antenna to wirelessly receive AC power from a power transmitting antenna in the power transmitting device; a power receiving circuit to convert the AC power received by the power receiving antenna into DC power and to output the DC power; a charge-discharge control circuit to control charging and discharging of an electrical storage device to be charged by the DC power output from the power receiving circuit; and a switching circuit connected between the power receiving circuit and the charge-discharge control circuit and between the electrical storage device or the other electrical storage device and the charge-discharge control circuit. The charge-discharge control circuit is booted by energy that is stored in the electrical storage device or another electrical storage device. The switching circuit is capable of switching between a first state in which power is supplied from the electrical storage device or the other electrical storage device to the charge-discharge control circuit and a second state in which power is supplied from the power receiving circuit to the charge-discharge control circuit.

With the above configuration, the charge-discharge control circuit is booted by energy that is stored in the electrical storage device or another electrical storage device. The switching circuit is capable of switching between: a first state in which power is supplied from the electrical storage device or the other electrical storage device to the charge-discharge control circuit; and a second state in which power is supplied from the power receiving circuit to the charge-discharge control circuit.

Accordingly, instead of energy supplied through wireless power transmission, the charge-discharge control circuit can be booted in advance with energy that is stored in the electrical storage device or the other electrical storage device. As a result, instability of wireless power transmission associated with boot of the charge-discharge control circuit can be eliminated.

As used herein, “boot” of the charge-discharge control circuit means booting of a processor, such as a CPU, that may be included in the charge-discharge control circuit.

The charge-discharge control circuit may be booted by energy that is stored in an electrical storage device to be charged by wirelessly transmitted electric power, or booted by energy that is stored in another electrical storage device. As used herein the “electrical storage device” is a rechargeable device such as a secondary battery or a capacitor for electrical storage purposes. Hereinafter, this electrical storage device may be referred to as the “first electrical storage device”. On the other hand, “another electrical storage device” may be a rechargeable device such as a secondary battery or a capacitor, as well as a non-rechargeable device such as a primary battery. Hereinafter, the other electrical storage device may be referred to as a “second electrical storage device”. In the present disclosure, even a non-rechargeable device is entitled to the term “electrical storage device” so long as the device stores some electrical energy. By providing the second electrical storage device, even if the remaining energy amount in the first electrical storage device is not enough, the energy in the second electrical storage device may be utilized to boot the charge-discharge control circuit.

The charge-discharge control circuit may be configured to be booted by energy that is stored in the electrical storage device (i.e., the first electrical storage device). In that case, the switching circuit is connected between the power receiving circuit and the charge-discharge control circuit, and between the electrical storage device and the charge-discharge control circuit. With this configuration, without providing another electrical storage device, the charge-discharge control circuit can be booted. Therefore, the system can be constructed at low costs.

In one embodiment, after the charge-discharge control circuit is booted, the switching circuit switches from the first state to the second state, and the charge-discharge control circuit begins charging the electrical storage device. With this configuration, after the charge-discharge control circuit has completed booting, charging of the electrical storage device utilizing wireless power transmission is begun. As a result, lowering of the transmission efficiency due to significant fluctuations in the characteristics of wireless power transmission during boot of the charge-discharge control circuit, and damage to the circuit elements, can be reduced.

The switching circuit may include a first diode connected between the power receiving circuit and the charge-discharge control circuit and a second diode connected between the electrical storage device or the other electrical storage device and the charge-discharge control circuit. The switching circuit may be configured so that it switches from the first state to the second state when the output voltage of the power receiving circuit exceeds the output voltage of the electrical storage device or the other electrical storage device.

With the above configuration, even in the case where the switching circuit does not include an element that can actively switch the current path, e.g., a switch, switching from the first state to the second state can be automatically performed with an appropriate timing. Therefore, the system can be constructed at low costs.

The switching circuit may include a switch that can switch between the first state and the second state. By providing a switch, the timing of switching between the first state and the second state can be set more flexibly.

The switching circuit may further include a switch control circuit that controls the switch to restrict an amount of time during which power is supplied from the electrical storage device or the other electrical storage device to the charge-discharge control circuit. With such a configuration, unwanted consumption of the electric power stored in the electrical storage device or the other electrical storage device can be suppressed.

The switching circuit may further include a detection circuit to detect an output voltage of the power receiving circuit. The switch control circuit may be configured to control the switch based on the output voltage detected by the detection circuit.

The switching circuit may further include a DC-DC converter circuit (hereinafter simply referred to as a “DC-DC converter”) connected between the electrical storage device and the charge-discharge control circuit. The DC-DC converter may be configured to step up or step down an output voltage from the electrical storage device and apply the output voltage to the charge-discharge control circuit. By using the DC-DC converter, the voltage output from the electrical storage device can be kept within a range of input voltage that is previously set for the charge-discharge control circuit.

In the present disclosure, a wireless power transmission system performs wireless power transmission by an electric field coupling method or a magnetic field coupling method, for example. The “electric field coupling method” refers to a method which wirelessly transmits electric power through electric field coupling between two or more transmission electrodes and two or more reception electrodes. The “magnetic field coupling method” refers to a method which wirelessly transmits electric power through magnetic field coupling between a power transmitting coil and a power receiving coil. In a wireless power transmission system based on the electric field coupling method, a power transmitting antenna includes two or more transmission electrodes, whereas a power receiving antenna includes two or more reception electrodes. In a wireless power transmission system based on the magnetic field coupling method, a power transmitting antenna includes a power transmitting coil, whereas a power receiving antenna includes a power receiving coil. Although the present specification will mainly describe a wireless power transmission system based on the electric field coupling method, the configuration of each embodiment of the present disclosure is similarly applicable to a wireless power transmission system based on the magnetic field coupling method.

A movable unit according to an embodiment of the present disclosure may include: a power receiving device according to an embodiment of the present disclosure; and an electric motor to be driven by energy that is stored in the electrical storage device. The movable unit may further include the electrical storage device.

The movable unit is not limited to a vehicle such as the aforementioned AGV, but encompasses any movable object that is driven by electric power. Examples of movable units may include an electric vehicle that includes an electric motor and one or more wheels. Such a vehicle may be the aforementioned AGV, an electric vehicle (EV), or an electric cart, for example. The “movable unit” within the meaning of the present disclosure also encompasses any movable object that lacks wheels. For example, bipedal robots, unmanned aerial vehicles (UAV, or so-called drones) such as multicopters, and manned electric aircraft are also encompassed within “movable units”.

A wireless power transmission system according to an embodiment of the present disclosure includes a power receiving device according to an embodiment of the present disclosure and the power transmitting device. A movable unit system according to an embodiment of the present disclosure includes the movable unit and the power transmitting device.

A movable unit system according to another embodiment of the present disclosure includes: the movable unit; and a control device to, when the movable unit has approached the power transmitting device, send a command for the switching circuit to enable supply of electric power from the electrical storage device or the other electrical storage device to the charge-discharge control circuit.

The movable unit system may further include a computer to monitor the position of the movable unit, and to notify the control device that the movable unit has approached the power transmitting device. In response to a notification from the managing device, the control device can send the command to the switching circuit.

A movable unit system according to still another embodiment of the present disclosure includes: the movable unit; and a sensor to detect that the movable unit has approached the power transmitting device. Upon detecting that the movable unit has approached the power transmitting device, the sensor sends a signal indicating this to the switching circuit. In response to the signal sent from the sensor, the switching circuit enables supply of electric power from the electrical storage device or the other electrical storage device to the charge-discharge control circuit.

Hereinafter, more specific embodiments of the present disclosure will be described. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, identical or similar constituent elements are denoted by identical reference numerals.

### Embodiments

FIG. 5 is a block diagram showing the configuration of a wireless power transmission system according to an illustrative embodiment of the present disclosure. The wireless power transmission system includes a power transmitting device 100 and a movable unit 10. The movable unit 10 includes a power receiving device 200, an electrical storage device 320, and an electric motor 330 for driving purposes. FIG. 5 also shows a power supply 20, which is an external element to the wireless power transmission system.

The power transmitting device 100 includes two transmission electrodes 120, a power transmitting circuit 110 to supply AC power to the two transmission electrodes 120, and a power transmission control circuit 150 to control the power transmitting circuit 110.

The power receiving device 200 includes two reception electrodes 220, a power receiving circuit 210, and a charge-discharge control circuit 290. While respectively being opposed to the two transmission electrodes 120, the two reception electrodes 220 receive AC power from the transmission electrodes 120 through electric field coupling. The power receiving circuit 210 converts the AC power received by the reception electrodes 220 into DC power, and outputs it. The electrical storage device 320 may be, for example, a secondary battery or a capacitor for electrical storage purposes. The charge-discharge control circuit 290 monitors the charge state of the electrical storage device 320, and controls charging and discharging. The charge-discharge control circuit 290 may be a battery management unit (BMU) that controls charging and discharging of a secondary battery, for example. The charge-discharge control circuit 290 also has the function of protecting cells in the electrical storage device 320 from overcharging, overdischarging, overcurrent, high temperature, low temperature, or other states. The switching circuit 270 is connected between the power receiving circuit 210 and the charge-discharge control circuit 290, and between the charge-discharge control circuit 290 and the electrical storage device 320. The switching circuit 270 is configured so as to be able to switch between: a first state in which power is supplied from the electrical storage device 320 to the charge-discharge control circuit 290; and a second state in which power is supplied from the power receiving circuit 210 to the charge-discharge control circuit 290. When a command to begin charge operation is given, the charge-discharge control circuit 290 performs an operation for booting by utilizing the energy in the electrical storage device 320. When boot is complete, the charge-discharge control circuit 290 allows the voltage which is output from the power receiving circuit 210 to be supplied to the electrical storage device 320 to charge the electrical storage device 320.

Hereinafter, the respective component elements will be described more specifically.

The power supply 20 supplies DC or AC power to the power transmitting circuit 110. The power supply 20 may be an AC power supply for commercial use, for example. The power supply 20 outputs an AC power with a voltage of 100 V and a frequency of 50 Hz or 60 Hz, for example. The power transmitting circuit 110 converts the AC power supplied from the power supply 20 into an AC power of a higher voltage and a higher frequency, and supplies it to the pair of transmission electrodes 120.

The electrical storage device 320 may be a rechargeable battery, such as a lithium-ion battery or a nickel-metal hydride battery. The electrical storage device 320 may be a high-capacitance and low-resistance capacitor, such as an electric double layer capacitor or a lithium-ion capacitor, for example. The movable unit 10 is able to move by driving the motor 330 with the electric power stored in the electrical storage device 320.

When the movable unit 10 moves, the amount of stored electricity in the electrical storage device 320 becomes lower. Therefore, recharging will be required in order to continue moving. Upon arriving at the power transmitting device 100 during its movement, the movable unit 10 performs charging.

The motor 330 may be any type of motor, such as a permanent magnet synchronous motor, an induction motor, a stepping motor, a reluctance motor, or a DC motor. The motor 330 rotates wheels of the movable unit 10 via a transmission mechanism, e.g., shafts and gears, thus causing the movable unit 10 to move. Although not shown in FIG. 5, the movable unit 10 further includes a motor control circuit. The motor control circuit may include various circuits, such as an inverter circuit, that are designed in accordance with the type of the motor 330. The movable unit 10 may further include other loads not shown in FIG. 5, e.g., various sensors, illumination devices, or imaging devices.

Although not particularly limited, the respective sizes of the housing of the movable unit 10 according to the present embodiment, the transmission electrodes 120, and the reception electrodes 220 may be set to the following sizes, for example. The length (i.e., the size along the Y direction) of each transmission electrode 120 may be set in a range from 50 cm to 20 m, for example. The width (i.e., the size along the X direction) of each transmission electrode 120 may be set in a range from 5 cm to 2 m, for example. The sizes along the traveling direction and the lateral direction of the housing of the movable unit 10 may be set in a range from 20 cm to 5 m, for example. The length of each reception electrode 220 may be set in a range from 5 cm to 2 m, for example. The width of each reception electrode 220a may be set in a range from 2 cm to 2 m, for example. The gap between two transmission electrodes, and the gap between two reception electrodes, may be set to a range from 1 mm to 40 cm, for example. However, these numerical ranges are not limiting.

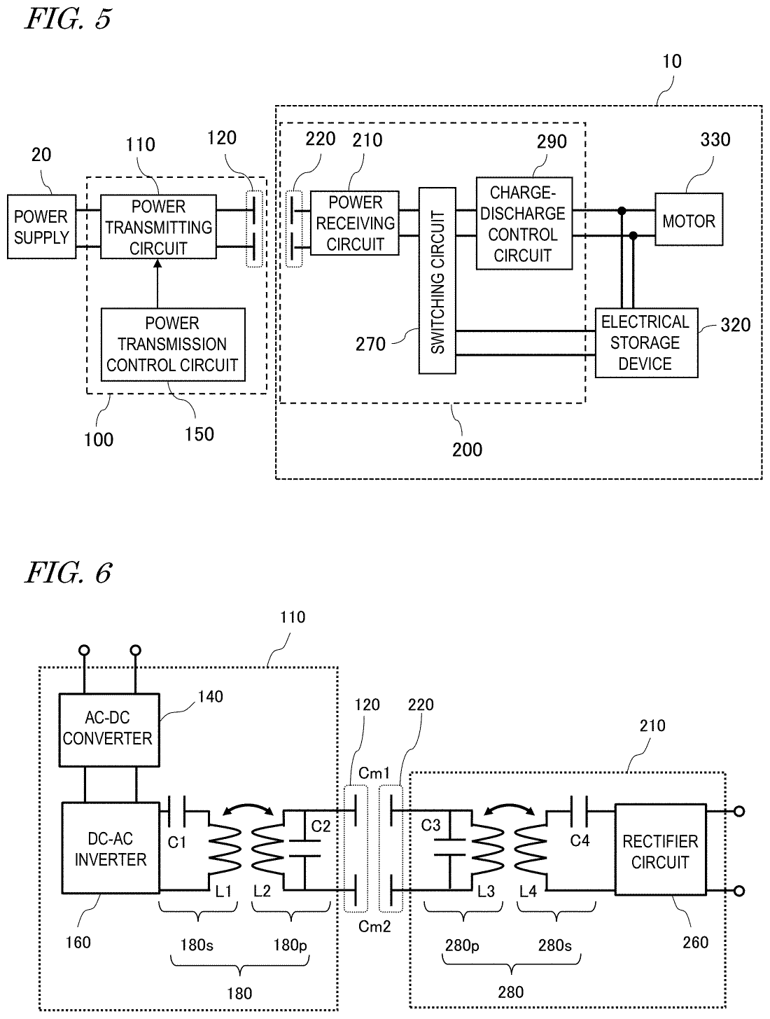

FIG. 6 is a diagram showing a more specific exemplary configuration of the power transmitting circuit 110 and the power receiving circuit 210. In this example, the power supply 20 is an AC power supply. The power transmitting circuit 110 includes an AC-DC converter circuit 140, a DC-AC inverter circuit 160, and a matching circuit 180. In the following description, the AC-DC converter circuit 140 may simply be referred to as the “converter 140”, and the DC-AC inverter circuit 160 may simply be referred to as the “inverter 160”.

The converter 140 is connected to the power supply 20. The converter 140 converts the AC power which is output from the power supply 20 into DC power, and outputs it. The inverter 160, which is connected to the converter 140, converts the DC power which is output from the converter 140 into an AC power of a relatively high frequency, and outputs it. The matching circuit 180, which is connected between the inverter 160 and the transmission electrodes 120, matches the inverter 160 and the transmission electrodes 120 in impedance. The transmission electrodes 120 send the AC power which is output from the matching circuit 180 out into space. Through electric field coupling, the reception electrodes 220 receive at least a portion of the AC power which is sent out from the transmission electrodes 120. A matching circuit 280, which is connected between the reception electrodes 220 and a rectifier circuit 260, matches the reception electrodes 220 and the rectifier circuit 260 in impedance. The rectifier circuit 260 converts the AC power which is output from the matching circuit 280 into DC power, and outputs it. The DC power which is output from the rectifier circuit 260 is sent to the switching circuit 270.

In the example shown in the figure, the matching circuit 180 of the power transmitting device 100 includes a series resonant circuit 180s which is connected to the inverter 160, and a parallel resonant circuit 180p which is connected to the transmission electrodes 120 and establishes inductive coupling with the series resonant circuit 180s. The series resonant circuit 180s of the power transmitter 100 includes a first coil L1 and a first capacitor C1 being connected in series. The parallel resonant circuit 180p of the power transmitter 100 includes a second coil L2 and a second capacitor C2 being connected in parallel. The first coil L1 and the second coil L2 constitute a transformer whose coupling is based on a predetermined coupling coefficient. The turns ratio between the first coil L1 and the second coil L2 is set to a value that realizes a desired step-up ratio. The matching circuit 180 steps up a voltage on the order of several ten to several hundred v which is output from the inverter 160 to a voltage on the order of several kV, for example.

The matching circuit 280 of the power receiving device 200 includes a parallel resonant circuit 280p which is connected to the reception electrodes 220 and a series resonant circuit 280s which is connected to the rectifier circuit 260 and establishes inductive coupling with the parallel resonant circuit 280p. The parallel resonant circuit 280p includes a third coil L3 and a third capacitor C3 being connected in parallel. The series resonant circuit 280s of the power receiving device 200 includes a fourth coil L4 and a fourth capacitor C4 being connected in series. The third coil L3 and the fourth coil L4 constitute a transformer whose coupling is based on a predetermined coupling coefficient. The turns ratio between the third coil L3 and the fourth coil L4 is set to a value that realizes a desired step-down ratio. The matching circuit 280 steps down a voltage on the order of several kV which is received by the reception electrodes 220 to a voltage on the order of several ten to several hundred v, for example.

Each coil in the resonant circuits 180s, 180p, 280p and 280s may be a planar coil or a laminated coil formed on a circuit board, or a wound coil in which a copper wire, a litz wire, a twisted wire or the like is used, for example. For each capacitor in the resonant circuits 180s, 180p, 280p and 280s, any type of capacitor having a chip shape or a lead shape can be used, for example. A capacitance between two wiring lines with air interposed between them may be allowed to function as each capacitor. The self-resonance characteristics that each coil possesses may be utilized in the place of any such capacitor.

The resonant frequency f0 of the resonant circuits 180s, 180p, 280p and 280s is typically set to be equal to the transmission frequency f1 during power transmission. It is not necessary for the resonant frequency f0 of each of the resonant circuits 180s, 180p, 280p and 280s to be exactly equal to the transmission frequency f1. The resonant frequency f0 of each may be set to a value in the range of about 50 to about 150% of the transmission frequency f1, for example. The frequency f1 of the power transmission may be e.g. 50 Hz to 300 GHz; 20 kHz to 10 GHz in one example; 20 kHz to 20 MHz in another example; and 80 kHz to 14 MHz in still another example.

In the present embodiment, what exists between the transmission electrodes 120 and the reception electrodes 220 is an air gap, with a relatively long distance therebetween (e.g., about 10 mm). Therefore, the capacitances Cm1 and Cm2 between the electrodes are very small, and impedances of the transmission electrodes 120 and the reception electrodes 220 are very high (e.g., on the order of several kΩ). On the other hand, the impedances of the inverter 160 and the rectifier circuit 260 are as low as about several Ω. In the present embodiment, the parallel resonant circuits 180p and 280p are disposed so as to be closer to, respectively, the transmission electrodes 120 and the reception electrodes 220; and the series resonant circuits 180s and 280s are disposed closer to, respectively, the inverter 160 and the rectifier circuit 260. Such configuration facilitates impedance matching. A series resonant circuit has zero (0) impedance during resonance, and therefore is suitable for matching with a low impedance. On the other hand, a parallel resonant circuit has an infinitely large impedance during resonance, and therefore is suitable for matching with a high impedance. Thus, as in the configuration shown in FIG. 6, disposing a series resonant circuit on the circuit with low impedance and disposing a parallel resonant circuit on the electrode with high impedance facilitates impedance matching.

Note that, in configurations where the distance between the transmission electrodes 120 and the reception electrodes 220 is shortened, or a dielectric is disposed therebetween, the electrode impedance will be so low that an asymmetric resonant circuit configuration is not needed. In the absence of impedance matching issues, one or both of the matching circuits 180 and 280 may be omitted. In the case of omitting the matching circuit 180, the inverter 160 and the transmission electrodes 120 are directly connected. In the case of omitting the matching circuit 280, the rectifier circuit 260 and the reception electrodes 220 are directly connected. In the present specification, a configuration where the matching circuit 180 is provided also qualifies as a configuration in which the inverter 160 and the transmission electrodes 120 are connected. Similarly, a configuration where the matching circuit 280 is provided also qualifies as a configuration in which the rectifier circuit 260 and the reception electrodes 220 are connected.

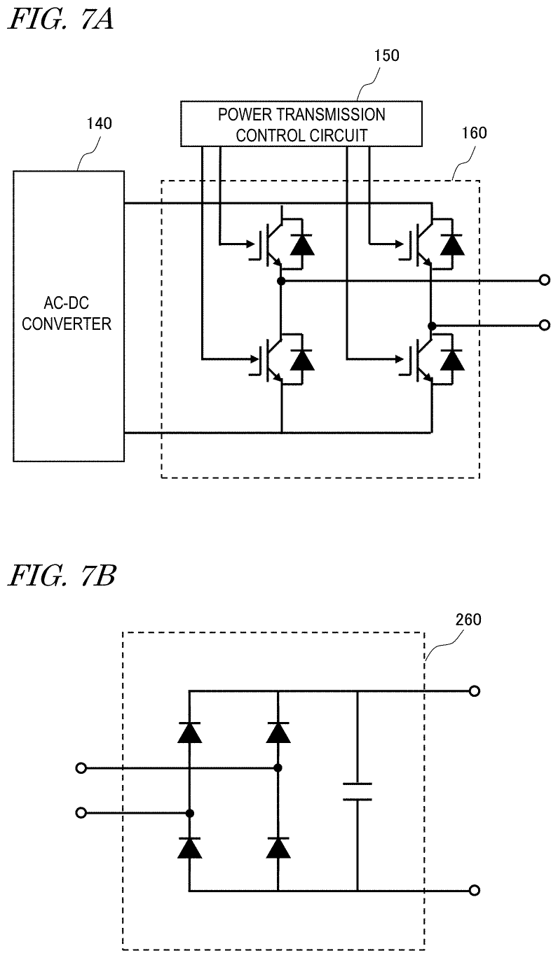

FIG. 7A is a diagram schematically showing an exemplary configuration for the inverter 160. In this example, the inverter 160 is a full-bridge inverter circuit that includes four switching elements and the power transmission control circuit 150. Each switching element may be a transistor switch such as an IGBT or a MOSFET. The power transmission control circuit 150 includes a gate driver which outputs a control signal to control the ON (conducting) or OFF (non-conducting) state of each switching element and a microcontroller unit (MCU) which causes the gate driver to output a control signal. Instead of the full-bridge inverter that is shown in the figure, a half-bridge inverter, or any other oscillation circuit, e.g., that of class E, may also be used.

FIG. 7B is a diagram schematically showing an exemplary configuration for the rectifier circuit 260. In this example, the rectifier circuit 260 is a full-wave rectifier circuit including a diode bridge and a smoothing capacitor. The rectifier circuit 260 may have any other rectifier configuration. The rectifier circuit 260 converts the received AC energy into DC energy which is available for use by the load, such as the electrical storage device 320.

Note that the configurations shown in FIGS. 6 to 7B are only examples; depending on the required functions or characteristics, the circuit configuration may be changed. For example, the circuit configuration shown in FIG. 3 may be adopted.

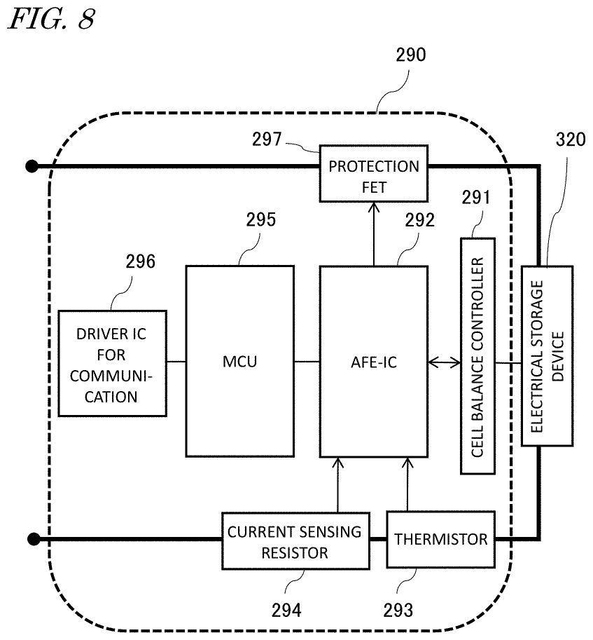

FIG. 8 is a diagram showing an exemplary configuration for the charge-discharge control circuit 290. In this example, the electrical storage device 320 is a secondary battery including a plurality of cells. The charge-discharge control circuit 290 in this example includes a cell balance controller 291, an analog front-end IC (AFE-IC) 292, a thermistor 293, a current sensing resistor 294, an MCU 295, a driver IC 296 for communication purposes, and a protection FET 297. The cell balance controller 291 is a circuit which equalizes the stored electric energies in the respective cells of the electrical storage device 320. The AFE-IC 292 is a circuit which controls the cell balance controller 291 and the protection FET 297 based on a cell temperature measured by the thermistor 293 and a current detected by the current sensing resistor 294. The MCU 295 is a circuit which controls communications with other circuits via the driver IC 296 for communication purposes. Note that the configuration shown in FIG. 8 is only an example; depending on the required functions or characteristics, the circuit configuration may be changed.

When the movable unit 10 begins charging the electrical storage device 320, the MCU 295 of the charge-discharge control circuit 290 needs to have completed booting. When supplying electric power for this boot through wireless power transmission, the voltage and current in the circuitry of the power transmitting device 100 and the movable unit 10 may significantly change due to impedance fluctuations occurring during boot. This may risk degrading the transmission efficiency, damaging circuit elements, or in the case where an tolerable range of input voltage to the charge-discharge control circuit 290 is defined, exceeding that range. Therefore, in the present embodiment, rather than booting the charge-discharge control circuit 290 with the electric power supplied by wireless power transmission, the energy stored in the electrical storage device 320 is utilized to boot the charge-discharge control circuit 290 in advance. In this while, the supply of electric power from the power receiving circuit 210 to the charge-discharge control circuit 290 is stopped by the switching circuit 270. As a result, lowering of the transmission efficiency due to impedance fluctuations occurring during boot of the charge-discharge control circuit 290, and damage to the circuit elements can be reduced.

Hereinafter, exemplary configurations for the switching circuit 270 will be described.

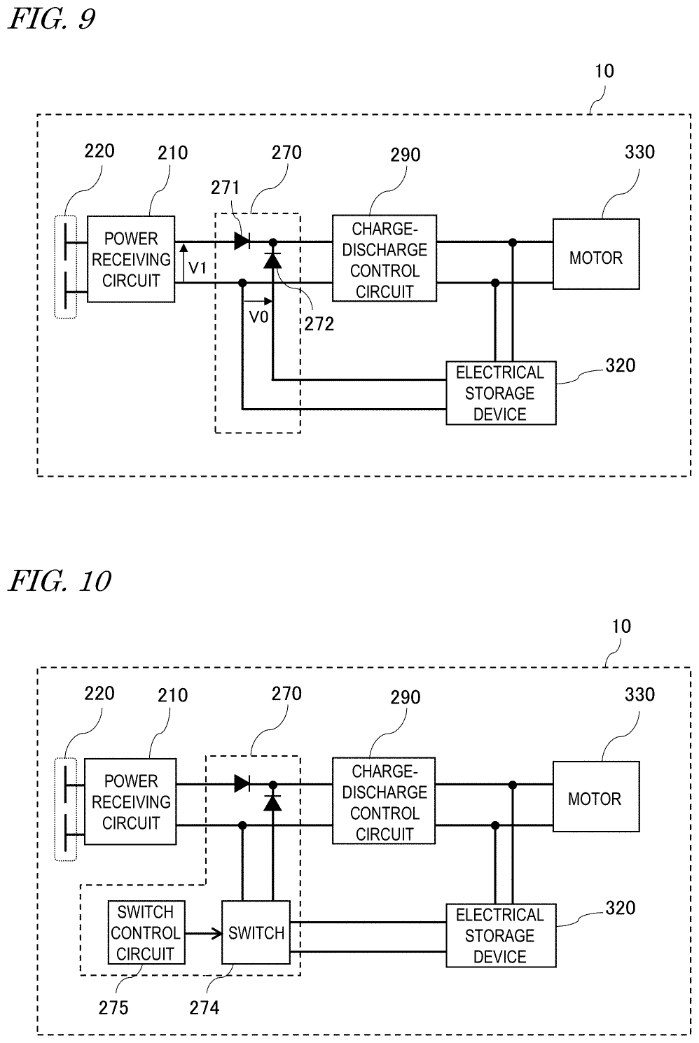

FIG. 9 is a diagram showing an exemplary configuration of the switching circuit 270. The switching circuit 270 in this example includes a first diode 271 and a second diode 272. The first diode 271 is connected between the power receiving circuit 210 and the charge-discharge control circuit 290. The second diode 272 is connected between the electrical storage device 320 and the charge-discharge control circuit 290. As in this example, the switching circuit 270 may include elements for preventing reverse current, such as the diodes 271 and 272. With such a configuration, when the output voltage V1 of the power receiving circuit 210 exceeds the output voltage V0 of the electrical storage device 320, the transmission path automatically switches. In other words, when V1<V0, power is supplied from the electrical storage device 320 to the charge-discharge control circuit 290; but when V1>V0, power is supplied from the power receiving circuit 210 to the charge-discharge control circuit 290. Herein, the output voltage of the power receiving circuit 210 may be designed so as to exceed the output voltage of the electrical storage device 320 as soon as the charge-discharge control circuit 290 completes booting. Thus, charging through wireless power transmission is begun in a state where the charge-discharge control circuit 290 has completed booting and the impedance has become stable. As a result, instability of wireless power transmission can be eliminated.

FIG. 10 is a diagram showing another exemplary configuration of the switching circuit 270. In this example, the switching circuit 270 includes a switch 274 and a switch control circuit 275. The switch 274 includes one or more switching elements, and is able to switch between ON and OFF states of a current path from the electrical storage device 320 to the charge-discharge control circuit 290. By controlling the switch 274, the switch control circuit 275 is able to restrict the amount of time during which power is supplied from the electrical storage device 320 to the charge-discharge control circuit 290. With such a configuration, unwanted consumption of the electric power stored in the electrical storage device 320 can be suppressed.

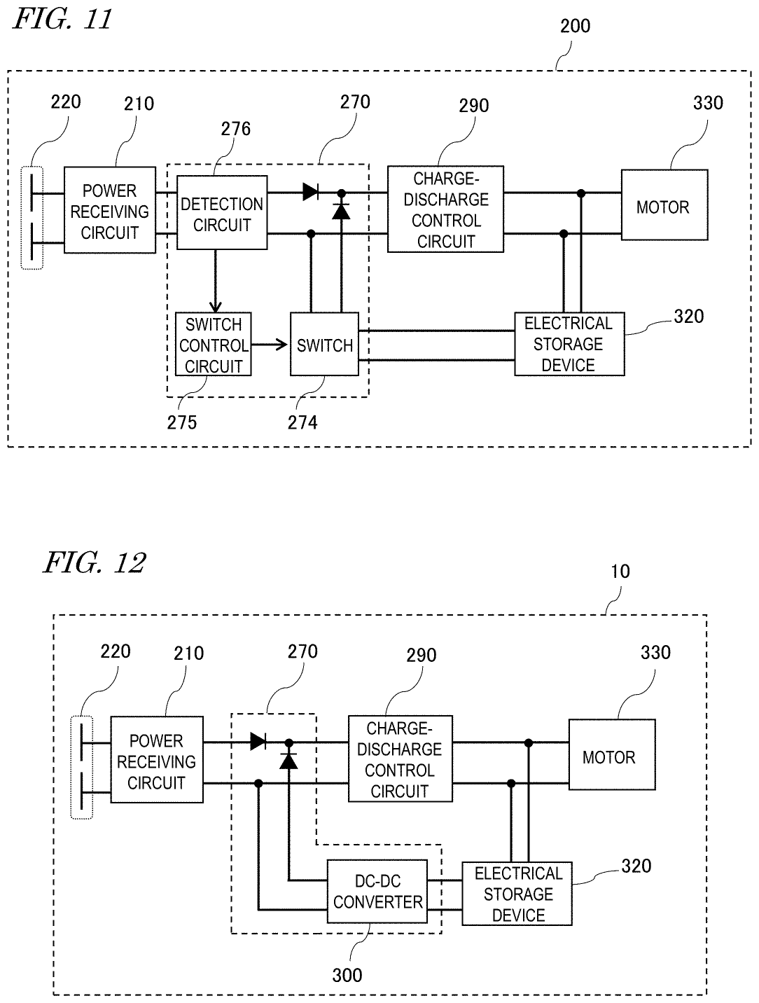

FIG. 11 is a diagram showing still another exemplary configuration of the switching circuit 270. In this example, in addition to the switch 274 and the switch control circuit 275, the switching circuit 270 further includes a detection circuit 276. The detection circuit 276 detects the output voltage of the power receiving circuit 210. Based on the output voltage detected by the detection circuit 276, the switch control circuit 275 controls the switch 274. When the output voltage of the power receiving circuit 210 becomes equal to or greater than a previously-set threshold value, for example, the switch control circuit 275 controls the switch 274 to enable supplying of power from the electrical storage device 320 to the charge-discharge control circuit 290. With such a configuration, it is possible to switch the current path in the switching circuit 270 with an appropriate timing. Therefore, unwanted consumption of electric power in the electrical storage device 320 can be suppressed.

FIG. 12 is a diagram showing still another exemplary configuration of the switching circuit 270. In this example, the switching circuit 270 further includes a DC-DC converter 300 that is connected between the electrical storage device 320 and the charge-discharge control circuit 290. The DC-DC converter 300 steps up or steps down the output voltage from the electrical storage device 320, and applies the output voltage to the charge-discharge control circuit 290. When the input voltage of the charge-discharge control circuit 290 is higher than the output voltage of the electrical storage device 320, a step-up DC-DC converter is used. By using the DC-DC converter 300, the voltage output from the electrical storage device 320 can be kept within a range of input voltage that is set for the charge-discharge control circuit 290. FIG. 12 shows a configuration resulting from adding the DC-DC converter 300 to the configuration in FIG. 9; alternatively, the DC-DC converter 300 may be added to the configuration of FIG. 10 or FIG. 11.

Next, changes in the path of power transmission to occur during boot and after boot of the charge-discharge control circuit 290 according to the present embodiment will be described.

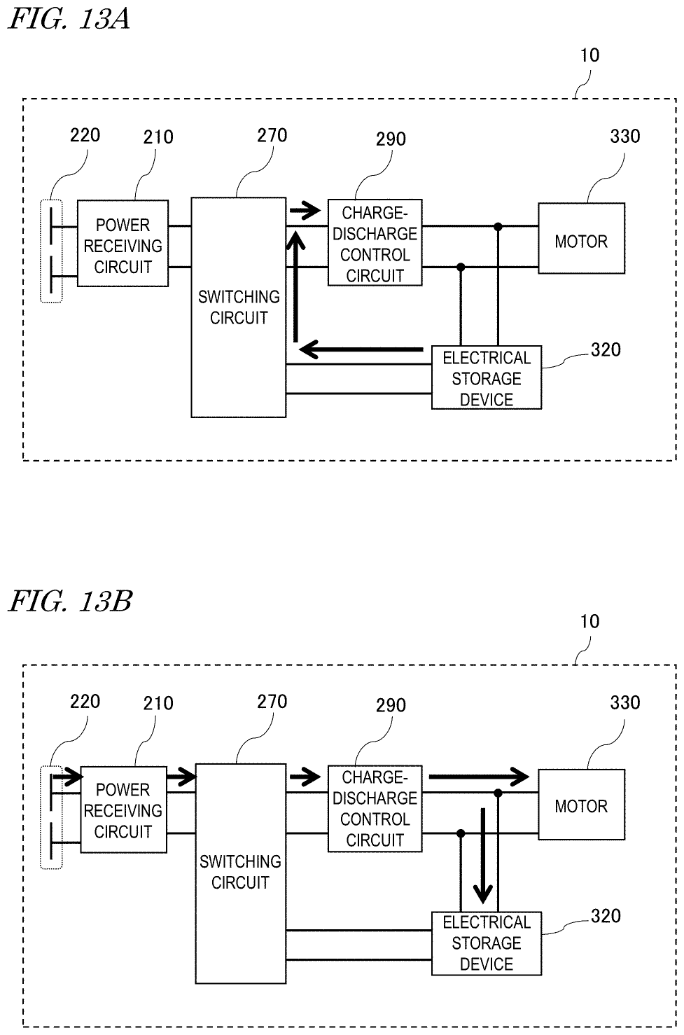

FIG. 13A is a diagram schematically showing a path of power transmission existing while the charge-discharge control circuit 290 is performing an operation for booting. In this state, as indicated by arrows in FIG. 13A, electric power is transmitted from the electrical storage device 320, via the switching circuit 270, to the charge-discharge control circuit 290. In this while, electric power from the power receiving circuit 210 is cut by the switching circuit 270.

FIG. 13B is a diagram schematically showing a path of power transmission after the charge-discharge control circuit 290 has completed booting. In this state, as indicated by arrows in FIG. 13B, the electric power which was received by the reception electrodes 220 and rectified by the power receiving circuit 210 goes through the switching circuit 270 so as to be supplied to the charge-discharge control circuit 290. The charge-discharge control circuit 290 utilizes this electric power to supply power to the electrical storage device 320 and the motor 330 as well as other loads. In this state, since impedance fluctuations of the charge-discharge control circuit 290 are small, the voltage in the circuitry of the movable unit 10 will not be too large. Therefore, the risks of damaging elements within the circuitry can be reduced.

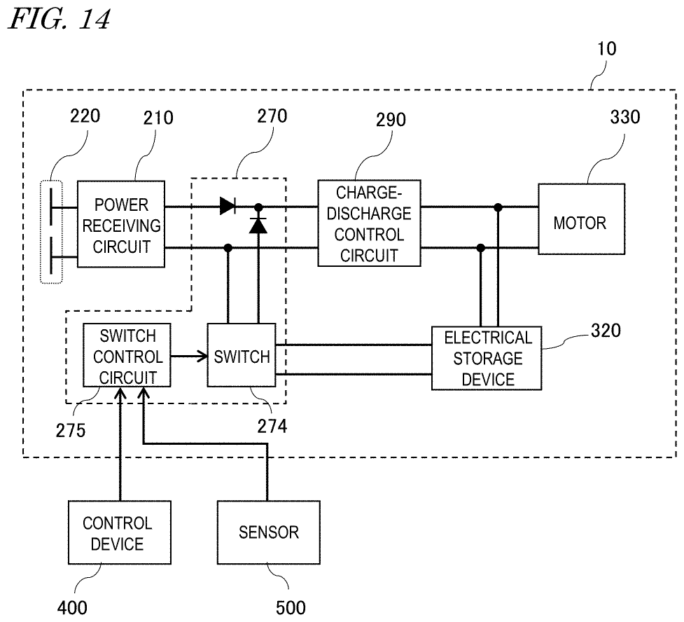

FIG. 14 is a diagram showing another exemplary configuration according to the present embodiment. The movable unit system in this example further includes a control device 400 and a sensor 500.

The control device 400 is a computer that manages traveling operations of the movable unit 10. In a movable unit system including one or more movable units 10, the control device 400 monitors the position of each movable unit 10, and sends a command for each movable unit 10 to move. The control device 400 performs wireless communications between itself and each movable unit 10 so as to constantly monitor the position of each movable unit 10. When the movable unit 10 approaches the power transmitting device 100, the control device 400 sends to the switching circuit 270 a command to enable supply of electric power from the electrical storage device 320 to the charge-discharge control circuit 290. Upon receiving this command, the switch control circuit 275 in the switching circuit 270 controls the switch 274 to enable supply of electric power from the electrical storage device 320 to the charge-discharge control circuit 290. As a result, the charge-discharge control circuit 290 is able to begin operations for booting, by utilizing the electric power in the electrical storage device 320. In the example of FIG. 14, the switch control circuit 275 includes various circuits, such as a communication circuit and a microcontroller unit (MCU). The control device 400 may have the function of grasping the position of each movable unit 10 on the basis of a command from a computer in an upper system that manages the entire movable unit system. Thus, the movable unit system may further include a computer which monitors the position of a movable unit 10 and which notifies the control device 400 that the movable unit 10 has approached the power transmitting device 100.

Instead of controlling the switch 274 on the basis of a command from the control device 400, the switching circuit 270 may control the switch 274 in response to a signal from the sensor 500. The sensor 500 in this example detects that the movable unit 10 has approached the power transmitting device 100. The sensor 500, which is mounted on the power transmitting device 100 or the movable unit 10, detects that the movable unit 10 has approached the power transmitting device 100 by a sensing method utilizing light, radio waves, ultrasonic waves, or the like, for example. In the case where the movable unit 10 includes the sensor 500, an item for improving the detection accuracy, e.g., a reflector, may be disposed near the power transmitting device 100. Upon detecting that the movable unit 10 has approached the power transmitting device 100 and hence a position where charging is possible, the sensor 500 sends a signal indicating this to the switching circuit 270 in the movable unit 10. In response to this signal, the switch control circuit 275 in the switching circuit 270 controls the switch 274 to enable supply of electric power from the electrical storage device 320 to the charge-discharge control circuit 290. As a result, the charge-discharge control circuit 290 is able to begin an operation for booting by utilizing electric power in the electrical storage device 320.

In the above configuration, boot of the charge-discharge control circuit 290 can be begun with an appropriate timing when the movable unit 10 approaches the power transmitting device 100. The timing of sending a signal from the control device 400 or the sensor 500 may be set by taking into consideration the amount of time needed for the correspond charge-discharge control circuit 290 to boot and the velocity of the movable unit 10. For example, the signal may be sent at the timing when the amount of time needed after the signal is sent and until at least a portion of the reception electrodes 220 becomes opposed to the transmission electrodes 120 is equal to or greater than the amount of time needed after boot of the charge-discharge control circuit 290 is begun and until it is completed. Thus, in a state where the charge-discharge control circuit 290 has completed booting, the movable unit 10 reaches a position where it can be charged. As a result, charging can be immediately begun.

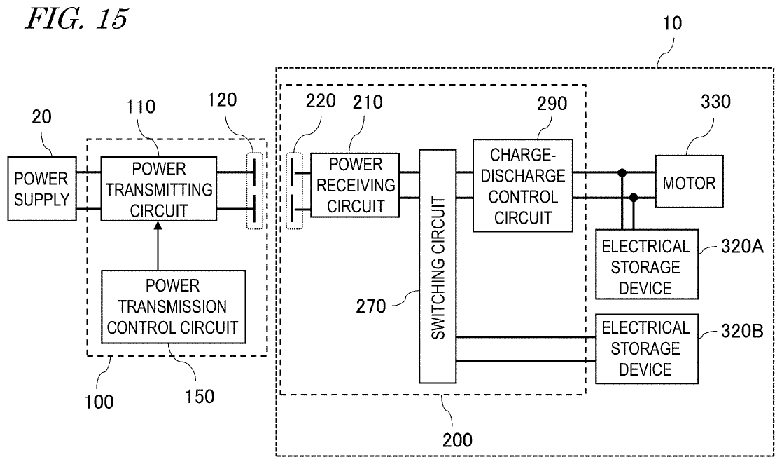

FIG. 15 is a diagram showing a variation of the present embodiment. The movable unit 10 of this variation includes a first electrical storage device 320A and a second electrical storage device 320B. The first electrical storage device 320A is connected to the charge-discharge control circuit 290, and is charged by electric power which is supplied through wireless power transmission. The first electrical storage device 320A is not connected to the switching circuit 270. The second electrical storage device 320B is connected to the switching circuit 270, and supplies electric power for booting the charge-discharge control circuit 290. The second electrical storage device 320B may be not only a secondary battery or a capacitor for electrical storage purposes, but also a primary battery. The configuration and operation of the switching circuit 270 are similar to those in the above-described embodiment. The aforementioned effects can be attained also by such a configuration.

### Other Embodiments

In the above embodiments, electric power is transmitted between two transmission electrodes 120 and two reception electrodes 220; however, the number of transmission electrodes and the number of reception electrodes are not limited to two. There may be three or more transmission electrodes and three or more reception electrodes. Hereinafter, as an example, an example system in which four transmission electrodes and four reception electrodes are included will be described.

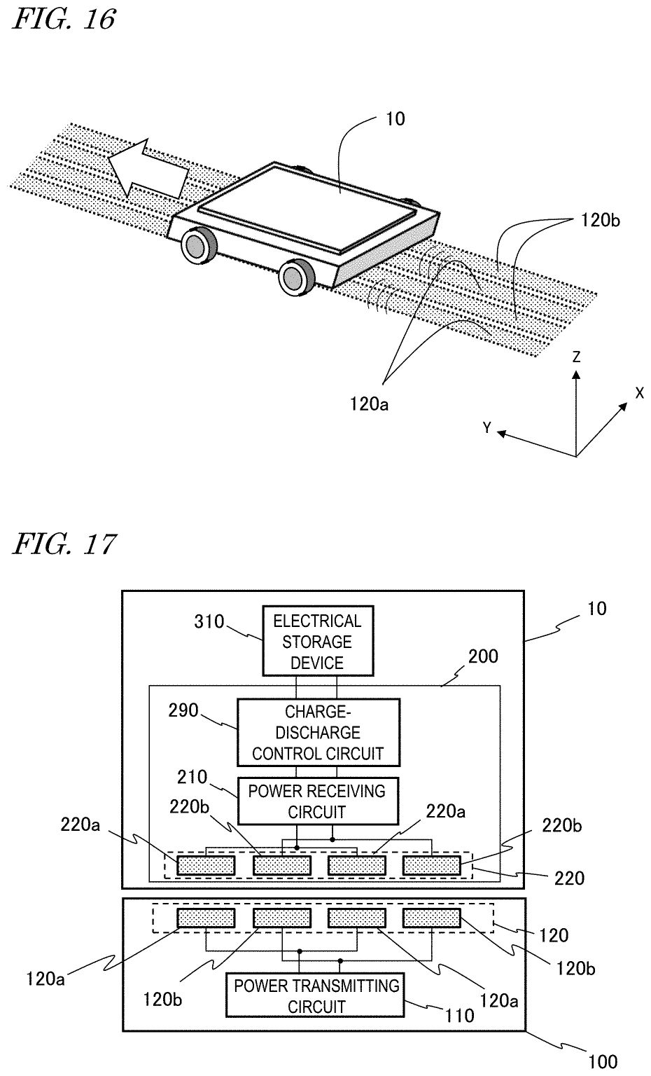

FIG. 16 is a perspective view schematically showing an example wireless power transmission system in which four transmission electrodes and four reception electrodes are included. FIG. 17 is a block diagram showing a general configuration of this system. In this example, the power transmitting device 100 includes two first transmission electrodes 120a and two second transmission electrodes 120b. The first transmission electrodes 120a and the second transmission electrodes 120b are arranged in an alternating manner. Similarly, the power receiving device 200 includes two first reception electrodes 220a and two second reception electrodes 220b. The two first reception electrodes 220a and the two second reception electrodes 220b are arranged in an alternating manner. During power transmission, the two first reception electrodes 220a are opposed respectively to the two first transmission electrodes 120a, and the two second reception electrodes 220b are opposed to the two second transmission electrodes 120b. The power transmitting circuit 110 includes two terminals to output AC power. One terminal is connected to the two first transmission electrodes 120a, whereas the other terminal is connected to the two second transmission electrodes 120b. During power transmission, the power transmitting circuit 110 applies a first voltage to the two first transmission electrodes 120a, and applies a second voltage of an opposite phase to the first voltage to the two second transmission electrodes 120b. As a result of this, through electric field coupling between the transmission electrode group 120 including four transmission electrodes and the reception electrode group 220 including four reception electrodes, electric power is wirelessly transmitted. Such a configuration provides an effect of suppressing a leakage field at a boundary between any two adjacent transmission electrodes. Thus, in each of the power transmitting device 100 and the power receiving device 200, the number of electrodes with which to perform power transmission or power reception is not limited to two, but may three or more. In either case, an electrode(s) to which a first voltage is applied at a given moment and an electrode(s) to which a second voltage of an opposite phase to the first voltage is applied are arranged in an alternating manner. As used herein, an “opposite phase” is defined to encompass a phase difference which is anywhere in the range from 90 degrees to 270 degrees, without being limited to the case where the phase difference is 180 degrees.

Although the pair of transmission electrodes 120 are installed on the ground in the above embodiments, the pair of transmission electrodes 120 may instead be installed on a lateral surface, e.g., a wall, or an overhead surface, e.g., a ceiling. Depending on the place and orientation in which the transmission electrodes 120 are installed, the arrangement and orientation of the reception electrodes 220 of the movable unit 10 are to be determined.

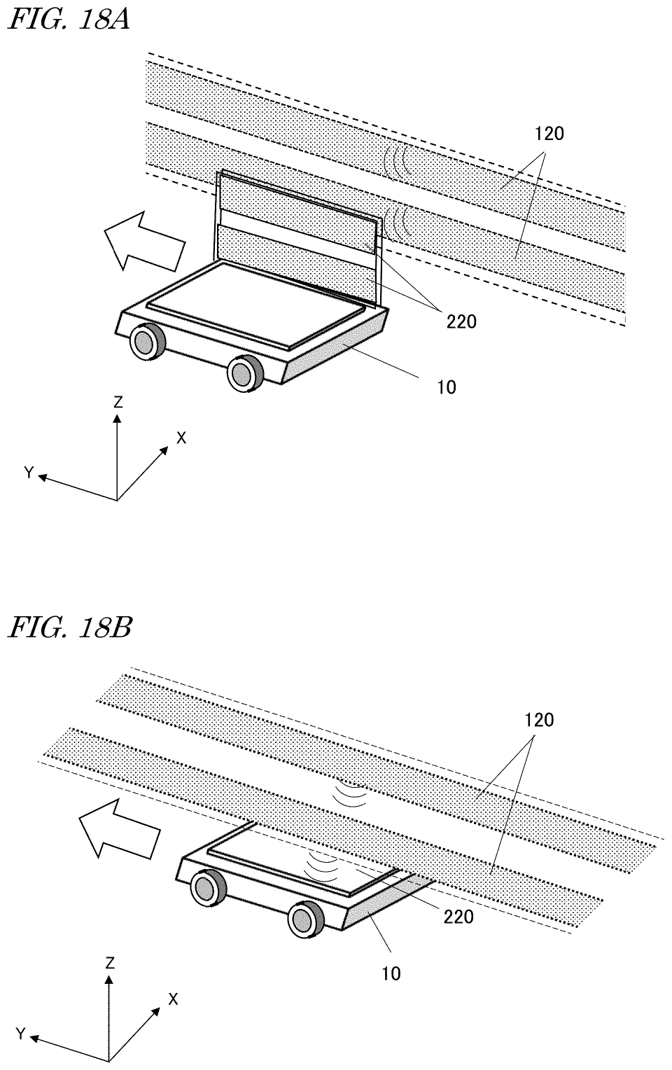

FIG. 18A shows an example where the transmission electrodes 120 are installed on a lateral surface e.g., a wall. In this example, the reception electrodes 220 are provided on a lateral side of the movable unit 10. FIG. 18B shows an example where the transmission electrodes 120 are installed on a ceiling. In this example, the reception electrodes 220 are provided on the top of the movable unit 10. As demonstrated by these examples, there may be a variety of arrangements for the transmission electrodes 120 and the reception electrodes 220.

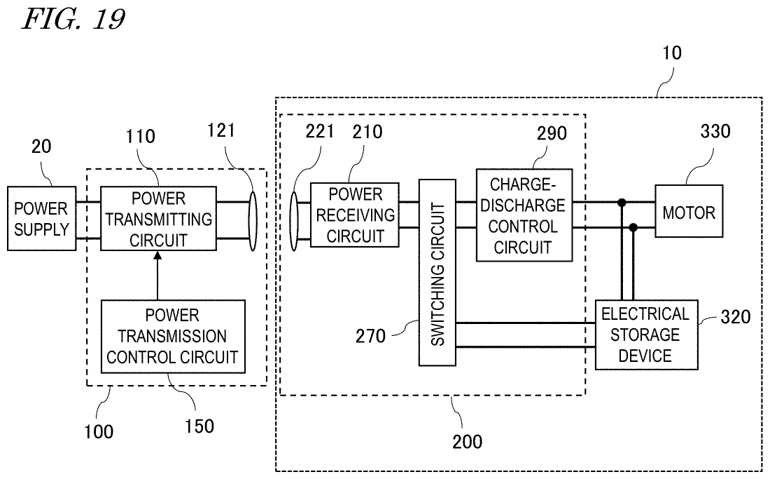

FIG. 19 is a diagram showing an exemplary configuration of a system in which electric power is wirelessly transmitted through magnetic field coupling between coils. In this example, a power transmitting coil 121 is provided instead of the transmission electrodes 120 shown in FIG. 5, and a power receiving coil 122 is provided instead of the reception electrodes 220. While the power receiving coil 122 is opposed to the power transmitting coil 121, electric power is wirelessly transmitted from the power transmitting coil 121 to the power receiving coil 221. With such a configuration, too, effects similar to those of the above embodiments are obtained.

A wireless power transmission system according to an embodiment of the present disclosure may be used as a system of transportation for articles within a factory, as mentioned above. The movable unit 10 functions as a cart having a bed on which to carry articles, and autonomously move in the factory to transport articles to necessary places. However, without being limited to such purposes, the wireless power transmission system and the movable unit according to the present disclosure are also usable for various other purposes. For example, without being limited to an AGV, the movable unit may be any other industrial machine, a service robot, an electric vehicle, a multicopter (so-called a drone), or the like. Without being limited to being used in a factory, the wireless power transmission system may be used in shops, hospitals, households, roads, runways, or other places, for example.

### INDUSTRIAL APPLICABILITY

The technique according to the present disclosure is applicable to any device that is driven with electric power. For example, it is suitably applicable to electric vehicles, such as automated guided vehicles (AGV).

### REFERENCE SIGNS LIST

10 movable unit

20 power supply

30 floor surface

100 power transmitting device

110 power transmitting circuit

120, 120a, 120b transmission electrode

140 AC-DC converter circuit

150 power transmission control circuit

160 inverter circuit

180 matching circuit

180s series resonant circuit

180p parallel resonant circuit

200 power receiving device

210 power receiving circuit

220, 220a, 220b reception electrode

260 rectifier circuit

270 switching circuit

280 matching circuit

280p parallel resonant circuit

280s series resonant circuit

290 charge-discharge control circuit

300 DC-DC converter

320 electrical storage device

330 electric motor

1. A power receiving device for use in a wireless power transmission system that includes a power transmitting device and the power receiving device, the power receiving device comprising:
a power receiving antenna to wirelessly receive AC power from a power transmitting antenna in the power transmitting device;
a power receiving circuit to convert the AC power received by the power receiving antenna into DC power and to output the DC power;
a charge-discharge control circuit to control charging and discharging of an electrical storage device to be charged by the DC power output from the power receiving circuit, the charge-discharge control circuit being booted by energy that is stored in the electrical storage device or another electrical storage device; and
a switching circuit connected between the power receiving circuit and the charge-discharge control circuit and between the electrical storage device or the other electrical storage device and the charge-discharge control circuit, the switching circuit being capable of switching between a first state in which power is supplied from the electrical storage device or the other electrical storage device to the charge-discharge control circuit and a second state in which power is supplied from the power receiving circuit to the charge-discharge control circuit.

2. The power receiving device of claim 1, wherein,
after the charge-discharge control circuit is booted,
the switching circuit switches from the first state to the second state, and
the charge-discharge control circuit begins charging the electrical storage device.

3. The power receiving device of claim 1, wherein,
the charge-discharge control circuit is booted by energy that is stored in the electrical storage device; and
the switching circuit is connected between the power receiving circuit and the charge-discharge control circuit and between the electrical storage device and the charge-discharge control circuit.

4. The power receiving device of claim 1, wherein,
the switching circuit includes:
a first diode connected between the power receiving circuit and the charge-discharge control circuit; and
a second diode connected between the electrical storage device or the other electrical storage device and the charge-discharge control circuit.

5. The power receiving device of claim 4, wherein, when an output voltage of the power receiving circuit exceeds an output voltage of the electrical storage device or the other electrical storage device, the first state switches to the second state.

6. The power receiving device of claim 1, wherein the switching circuit includes a switch to switch between the first state and the second state.

7. The power receiving device of claim 6, wherein the switching circuit further includes a switch control circuit that controls the switch to restrict an amount of time during which power is supplied from the electrical storage device or the other electrical storage device to the charge-discharge control circuit.

8. The power receiving device of claim 7, wherein,
the switching circuit further includes a detection circuit to detect an output voltage of the power receiving circuit; and
the switch control circuit controls the switch based on the output voltage detected by the detection circuit.

9. The power receiving device of claim 1, wherein,
the switching circuit further includes a DC-DC converter circuit connected between the electrical storage device and the charge-discharge control circuit; and
the DC-DC converter circuit steps up or steps down an output voltage of the electrical storage device and applies the output voltage to the charge-discharge control circuit.

10. The power receiving device of claim 1, wherein,
the power transmitting antenna includes two or more transmission electrodes; and
the power receiving antenna includes two reception electrodes to receive the AC power from the two or more transmission electrodes through electric field coupling.

11. A movable unit comprising:
the power receiving device of claim 1; and
an electric motor to be driven by energy that is stored in the electrical storage device.

12. A wireless power transmission system comprising:
the power receiving device of claim 1; and
the power transmitting device.

13. A movable unit system comprising:
the movable unit of claim 11; and
the power transmitting device.

14. A movable unit system comprising:
the movable unit of claim 11; and
a control device to, when the movable unit has approached the power transmitting device, send a command for the switching circuit to enable supply of electric power from the electrical storage device or the other electrical storage device to the charge-discharge control circuit.

15. The movable unit system of claim 14, further comprising a computer to monitor the position of the movable unit, and to notify the control device that the movable unit has approached the power transmitting device.

16. A movable unit system comprising:
the movable unit of claim 11; and
a sensor to detect that the movable unit has approached the power transmitting device, wherein,
in response to a signal sent from the sensor indicating that the movable unit has approached the power transmitting device, the switching circuit enables supply of electric power from the electrical storage device or the other electrical storage device to the charge-discharge control circuit.
